(19) United States
(12) Patent Application Publication
(10) Pub. No.: US 2009/0010696 A1
(43) Pub. Date: Jan. 8, 2009

(54) IMAGE FORMING APPARATUS HAVING CONTACT PREVENTING UNIT TO PREVENT PRINTING MEDIUM FROM CONTACTING DEVELOPMENT CARTRIDGE

(75) Inventor: Chun-seung YANG, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/058,862

(22) Filed: Mar. 31, 2008

(30) Foreign Application Priority Data
Jul. 3, 2007 (KR) 2007-66637

(51) Int. Cl. G03G 15/00

(52) U.S. Cl. 399/395

(57) ABSTRACT

An image forming apparatus includes a printing medium feeder which feeds a printing medium a developing cartridge which forms an image on the printing medium; a fusing unit which fuses the image on the printing medium; and a contact preventing unit between the developing cartridge and the fusing unit and contacts opposite sides of the printing medium to prevent contact between the printing medium and the developing cartridge.

### CROSS-REFERENCE TO RELATED APPLICATIONS

This application claims priority from Korean Patent Application No. 2007-66637, filed on Jul. 3, 2007, in the Korean Intellectual Property Office, the disclosure of which is incorporated herein by reference.

### BACKGROUND OF THE INVENTION

1. Field of the Invention

Aspects of the present invention relate to an image forming apparatus, and more particularly, to an image forming apparatus which prevents contact between a printing medium and a developing cartridge and reduces contamination of the printing medium.

2. Description of the Related Art

Generally, an image forming apparatus forms an image corresponding to image data on a printing medium, such as a sheet of paper, a transparency sheet, stationary, etc., according to a printing signal transmitted by a host device. Types of image forming apparatuses include printers, photocopiers, scanners and multi-function devices according to functions.

FIGS. 1A and 1B schematically illustrate a printing medium feeding path of a conventional image forming apparatus 10. As shown therein, a developer image T is formed on a printing medium P after the printing medium P passes through a developing cartridge 20 which applies a developer to the printing medium P. The developer image T is fused on the printing medium P by heat and pressure applied by a fusing unit 40.

However, in the conventional image forming apparatus 10, a trailing edge Pe of the printing medium P may contact a rear side 21 of the developing cartridge 20 while the printing medium P having the developer applied thereon is fed to the fusing unit 40. Then, the developer image contacts the rear side 21 and is contaminated. Also, the developer which is rubbed off on the rear side 21 contaminates a subsequent printing medium P.

To solve the foregoing problem, the conventional image forming apparatus 10 includes a contact preventing rib unit 30 which is provided between the developing cartridge 20 and the fusing unit 40 to prevent contact between the printing medium P and the developing cartridge 20. As shown in FIG. 1B, contact preventing ribs 31 and 33 formed on the contact preventing rib unit 30 protrude toward opposite sides of the printing medium P, and support the opposite sides of the printing medium P so that the printing medium P does not contact the casing rear side 21.

An example of a contact preventing rib unit 30 with inner left and right contact preventing ribs 33a and 33b and outer left and right contact preventing ribs 31a and 31b will now be described with reference to FIGS. 2A and 2B, which illustrate views from a perspective along the feeding path. If a printing medium P1 with a larger width or a printing medium P2 with a smaller width is fed to the fusing unit 40 along a predetermined feeding path as shown in FIG. 2A, inner left and right contact preventing ribs 33a and 33b or outer left and right contact preventing ribs 31a and 31b support the opposite sides of the printing medium P1 or P2, respectively, and prevent contact between the printing medium P1 or P2 and the rear side 21. However, as shown in FIG. 2B, if the printing medium P2, for example, deviates from the feeding path and is fed to the fusing unit 40 in a misaligned fashion, a first side Pa of the printing medium P2 contacts the rear side 21 while the developer on a second side Pb contaminates a contact preventing rib 33a.

That is, the conventional inner left and right contact preventing ribs 33a and 33b and outer left and right contact preventing ribs 31a and 31b cannot prevent the image formed on the printing medium P from becoming damaged due to the contact between the printing medium P and the developing cartridge 20 if the printing medium P deviates from the predetermined feeding path. Also, if the printing medium P deviates from the feeding path, the developer is rubbed onto the surface of the contact preventing ribs 31 and 33, and the developer further damages the image on the printing medium P.

### SUMMARY OF THE INVENTION

Accordingly, it is an aspect of the present invention to provide an image forming apparatus which prevents contact between a printing medium and a developing cartridge even in the case where the printing medium deviates from its feeding path.

Additional aspects and/or advantages of the present invention will be set forth in part in the description which follows and, in part, will be obvious from the description, or may be learned by practice of the present invention.

The foregoing and/or other aspects of the present invention are achieved by providing an image forming apparatus, including a printing medium feeder which feeds a printing medium along a feeding path, a developing cartridge which forms an image on the printing medium; a fusing unit which fuses the image on the printing medium; and a contact preventing unit between the developing cartridge and the fusing unit and which contacts opposite sides of the printing medium to prevent contact between the printing medium and the developing cartridge.

According to an aspect of the present invention, the contact preventing unit prevents the printing medium from deviating off a feeding path a distance which is more than a predetermined length that is larger than a difference between a width of a smallest printing medium and a width of a largest printing medium fed by the printing medium feeder.

According to an aspect of the present invention, the printing medium feeder employs one of a central feeding method to feed the printing medium based on a location of a center of the printing medium, or a side feeding method to feed the printing medium based on a location of one of the sides of the printing medium and which shifts the printing medium towards one of the sides in comparison with the central feeding method, and the contact preventing unit prevents the printing medium from deviating off the feeding path a distance which is more than a predetermined length that is larger than an alignment difference between the printing medium aligned by the central feeding method and the printing medium aligned by the side feeding method.

According to an aspect of the present invention, the contact preventing unit includes a contact preventing roller.

According to an aspect of the present invention, the contact preventing roller is tapered toward an inside of the feeding path.

According to an aspect of the present invention, the contact preventing roller is shaped like a cone.

According to an aspect of the present invention, the contact preventing roller includes a plurality of projections which are formed on a surface of the contact preventing roller which contacts one of the sides of the printing medium.

According to an aspect of the present invention, the image forming apparatus further includes a guide member located below the developing cartridge which guides the printing medium to the contact preventing unit, and an auxiliary contact preventing unit which is provided between the developing cartridge and the guide member to prevent the contact between the printing medium and the developing cartridge and to prevent the sides of the printing medium from deviating off the feeding path.

Additional aspects and/or advantages of the invention will be set forth in part in the description which follows and, in part, will be obvious from the description, or may be learned by practice of the invention.

### BRIEF DESCRIPTION OF THE DRAWINGS

The above and/or other aspects of the present invention will become apparent and more readily appreciated from the following description of the embodiments, taken in conjunction with the accompanying drawings of which:

FIGS. 1A and 1B schematically illustrate a conventional image forming apparatus;

FIGS. 2A and 2B schematically illustrate an example of a contact preventing rib of the conventional image forming apparatus;

FIG. 3 schematically illustrates an image forming apparatus according to an embodiment of the present invention;

FIG. 4 is a schematic rear perspective view of a contact preventing unit according to an embodiment of the present invention;

FIGS. 5A and 5B illustrate a contact process of the contact preventing unit and a printing medium according to an embodiment of the present invention;

FIG. 6 illustrates a relationship between the size of the printing medium and the length of the contact preventing unit shown in FIG. 4; and

FIG. 7 illustrates a relationship between a feeding method of the printing medium and the length of the contact preventing unit shown in FIG. 4.

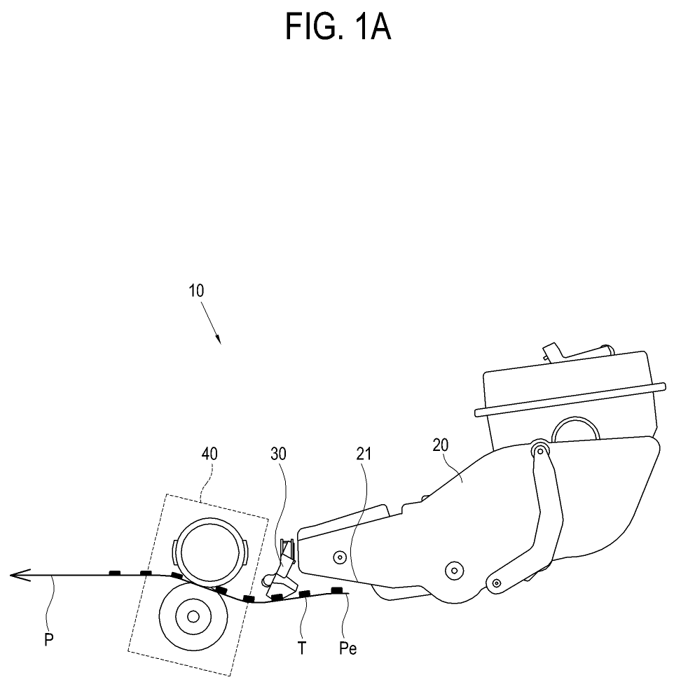

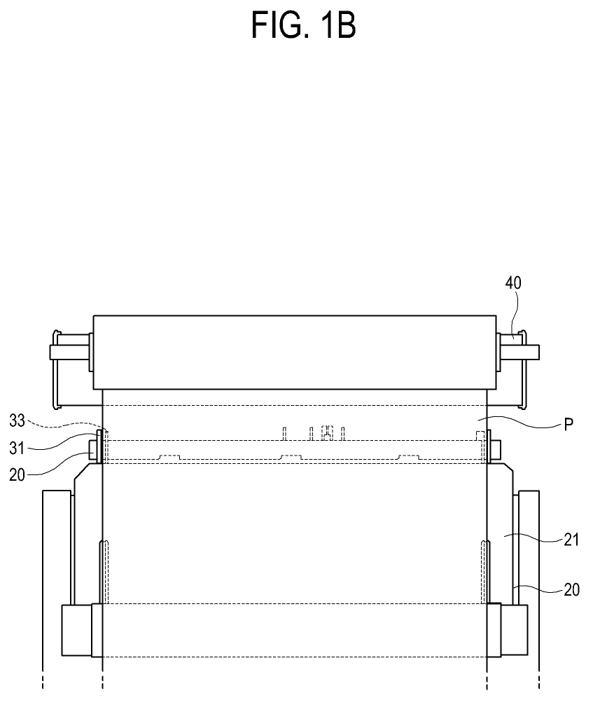

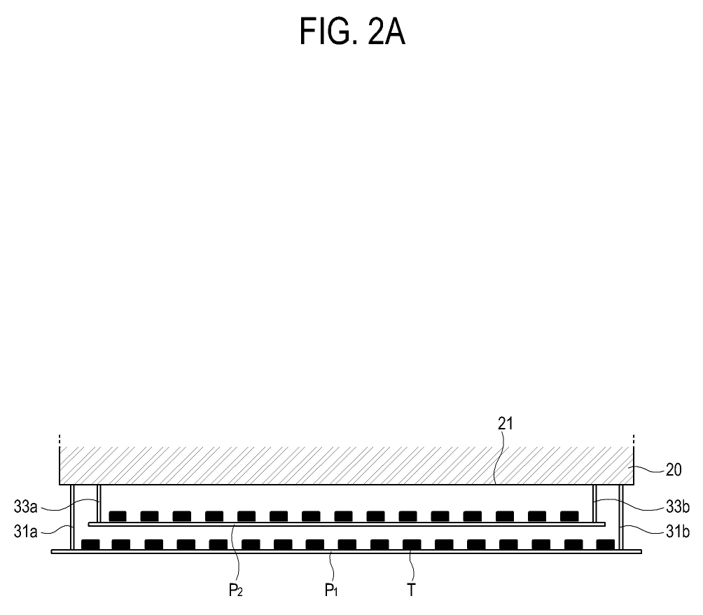

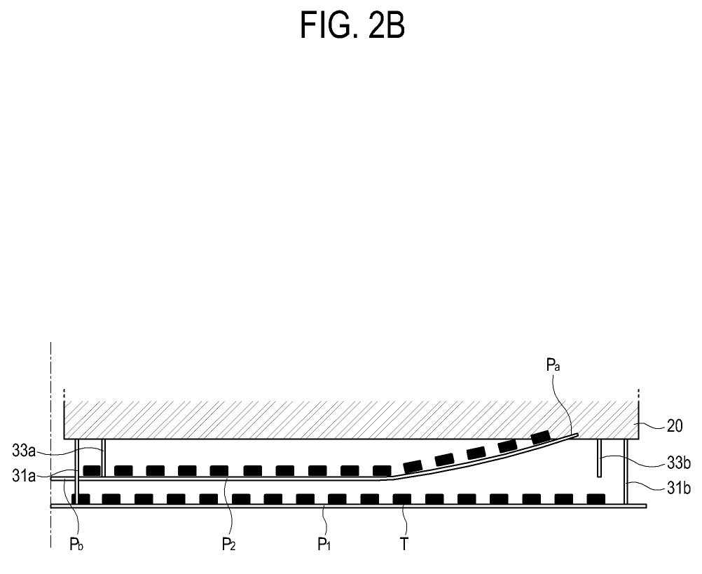

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

Hereinafter, embodiments of the present invention will be described with reference to the accompanying drawings, wherein like numerals refer to like elements and repetitive descriptions will be avoided as necessary.

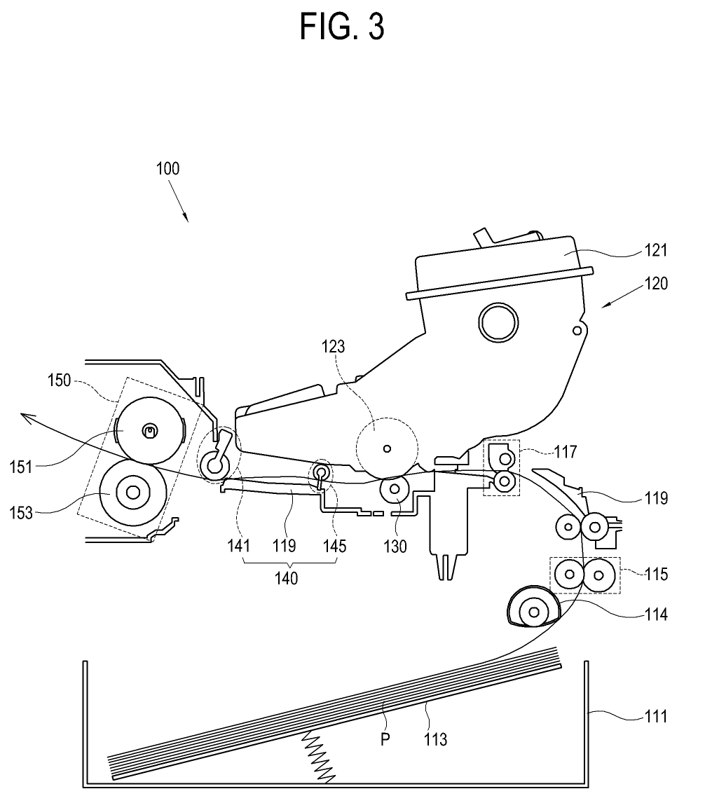

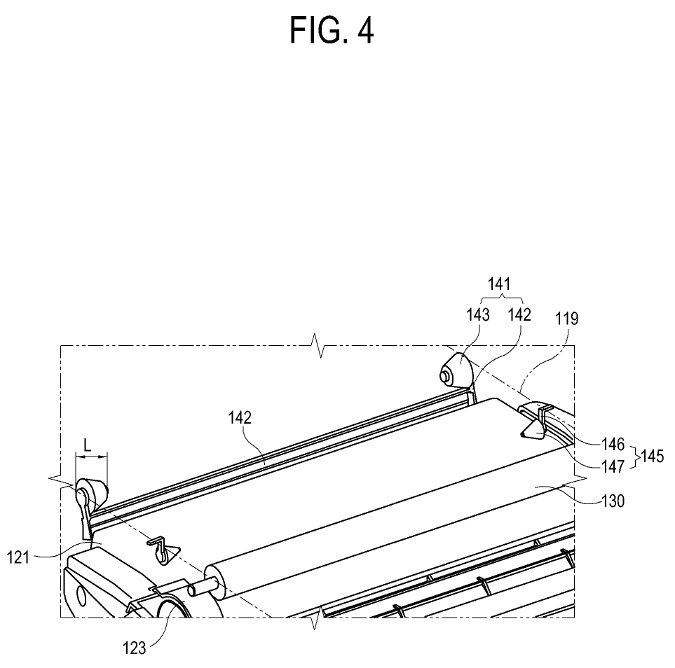

FIG. 3 schematically illustrates an image forming apparatus 100 according to an embodiment of the present invention. FIG. 4 is a rear perspective view of a developing cartridge 120 and a contact preventing unit 140.

As shown in FIGS. 3 and 4, the image forming apparatus 100 according to the present embodiment includes a printing medium feeder 110 which feeds a printing medium P, such as a sheet of paper, a transparency sheet, stationary, etc., along a feeding path, a developing cartridge 120 and a transfer unit 130 which form a developer image on the printing medium P fed by the printing medium feeder 110, a fusing unit 150 which fuses the developer image on the printing medium P by heat and pressure, and a contact preventing unit 140 which is provided between the developing cartridge 120 and the fusing unit 150 to prevent contact between the printing medium P and the developing cartridge 120.

The printing medium feeder 110 stores the printing medium P therein, and feeds the printing medium P to the developing cartridge 120 if a printing signal is transmitted from a host (not shown), such as, for example, a computer. The printing medium feeder 110 includes a printing medium cassette 111 which stores the printing medium P therein, a pickup roller 114 which picks up the printing medium P from the printing medium cassette 111 and registration rollers 115 which align a leading edge of the printing medium P. The printing medium feeder 110 may further include a guide member 119 which guides the printing medium P along a feeding path and a feed roller 117 which feeds the printing medium P along the feeding path.

The printing medium cassette 111 is detachably attached to a casing (not shown) and accommodates a plurality of printing media P therein. The printing medium cassette 111 includes a knock-up plate 113 which stores the printing medium P therein and moves upward and downward, i.e., towards and away from, the pickup roller 114.

The printing medium cassette 111 may store printing media P in different sizes. The printing medium cassette 111 may be plurally provided to store printing media P according to the different sizes, although it is understood that a single printing medium cassette 111 may also store printing media P of different sizes.

The pickup roller 114 rotates in contact with the printing medium P stored on the top of the knock-up plate 113 if the printing signal is transmitted from a host. The printing medium P is separated from the knock-up plate 113 due to a frictional force generated between the rotating pickup roller 114 and the printing medium P. At this point, the pickup roller 114 supplies a frictional force larger than the frictional force generated between printing media P to the printing medium P stored at the top of the stack of printing media P stored in the printing medium cassette 111, to prevent movement of the plural printing media P. According to an aspect, the pickup roller 114 moves together with a friction pad (not shown) which supplies a frictional force to a printing medium P at the bottom of the knock-up plate 113, to prevent the movement of plural printing media P.

The registration rollers 115 align the leading edge of the printing medium P picked up from the knock-up plate 113 by the pickup roller 114 and feeds the printing medium P to the developing cartridge 120. The registration rollers 115 may be various types, including a central feeding (CF) type which aligns the printing medium P based on a center of the front end of the printing medium P, and a side feeding (SF) type which aligns the printing medium P based on a side of the front end of the printing medium P. Since the CF and SF type registration rollers are well known to those skilled in the art, detailed descriptions thereof will be avoided here. It is understood that the registration rollers 115 may be either one of a CF type or an SF type, or alternatively, may be a combination of both a CF type and an SF type.

The feed roller 117 feeds the printing medium P, whose leading edge is aligned by the registration rollers 115, to the developing cartridge 120. The feed roller 117 may be plurally provided depending on the shape and length of the printing medium feeding path, although may be singularly provided as well.

The guide member 119 is provided along the printing medium feeding path, and guides movement of the printing medium P. The guide member 119 may be integrally formed in a main body frame (not shown) or may be separately provided.

The developing cartridge 120 applies a developer to the printing medium P to form an image. The developing cartridge 120 includes a developer casing 121 which stores the developer therein, and a photosensitive drum 123 which applies the developer to the printing medium P by a potential difference. The developing cartridge 120 is detachably attached to the main body frame to enable convenient replacement when the developer stored therein is exhausted. The transfer unit 130 supplies a transfer voltage to a rear side of the printing medium P and transfers the developer on the photosensitive drum 123 to the printing medium P. According to an aspect, the transfer unit 130 includes a transfer roller, although it is understood that more than one transfer roller may be used.

The contact preventing unit 140 prevents contact between the printing medium P having the developer thereon and the developer casing 121 of the developing cartridge 120 to prevent contamination of the printing medium P. The image forming apparatus 100 according to the present embodiment includes a main contact preventing unit 141 which is provided between the developing cartridge 120 and the fusing unit 150, and an auxiliary contact preventing unit 145 which is provided between the developing cartridge 120 and the guide member 119.

The main contact preventing unit 141 and the auxiliary contact preventing unit 145 prevent the trailing edge of the printing medium P from contacting the bottom surface of the developer casing 121 when the printing medium P having the developer image is fed to the fusing unit 150. As shown in FIG. 4, the main contact preventing unit 141 includes contact preventing roller 143, i.e, first and second contact preventing rollers 143, and holder members 142, i.e., first and second holder members 142, and the auxiliary contact preventing unit 145 includes auxiliary contact preventing rollers 147, i.e., first and second auxiliary contact preventing rollers 147, and auxiliary holder members 146, i.e., first and second auxiliary holder members 146. The contact preventing rollers 143 and the auxiliary contact preventing rollers 147 are rotatable. The holder members 142 and the auxiliary holder members 146 support the contact preventing rollers 143 and the auxiliary contact preventing rollers 147, respectively, to rotate with respect to the main body frame.

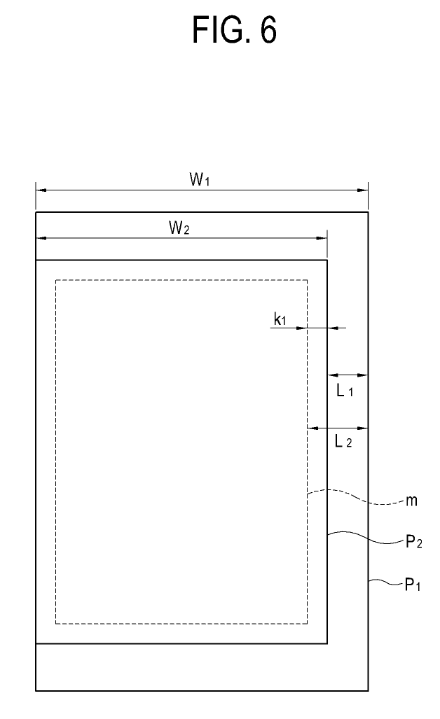

The contact preventing rollers 143 and the auxiliary contact preventing rollers 147 are provided to support a predetermined length of opposite sides of the printing medium P. The length L of one of the contact preventing roller 143 and one of the auxiliary contact preventing roller 147 is set to be within a side margin of the printing medium P on which the image is not formed. According to an aspect of the present invention, if the printing medium cassette 111 feeds printing media P1 and P2 having different sizes, as shown in FIG. 6, the length L of the contact preventing roller 143 and the auxiliary contact preventing roller 147 may be larger than a difference L1 between a width W1 of the large printing medium P1 and a width w2 of a small printing medium P2, and smaller than a length L2 which is the sum of L1 and a side margin k1 of the small printing medium P2. It is understood that the lengths L of the contact preventing roller 143 and the auxiliary contact preventing roller 147 are not required to be identical to each other.

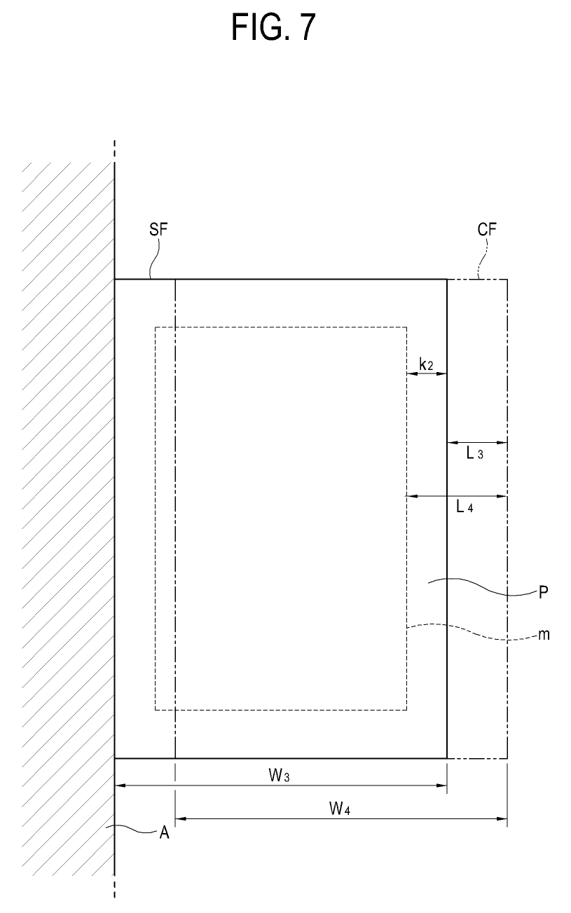

As shown in FIG. 7, the length L of the contact preventing roller 143 and the auxiliary contact preventing roller 147 may be set in consideration of printing medium feeding methods of the registration rollers 115. That is, an alignment difference L3 between the central feeding (CF) method and the side feeding (SF) method may be considered in designing the length L of the contact preventing roller 143 and the auxiliary contact preventing roller 147. The length L of the contact preventing roller 143 and the auxiliary contact preventing roller 147 may be larger than the alignment difference L3, and smaller than a length L4 which is the sum of L3 and a side margin k2 of the printing medium P which is fed using the side feeding (SF) method. It is understood that the image forming apparatus 100 may use either the SF method or the CF method, or alternatively, may use a combination of both the SF method and the CF method.

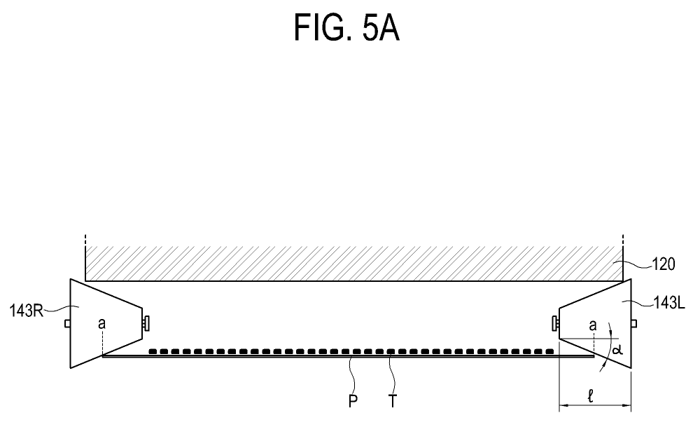

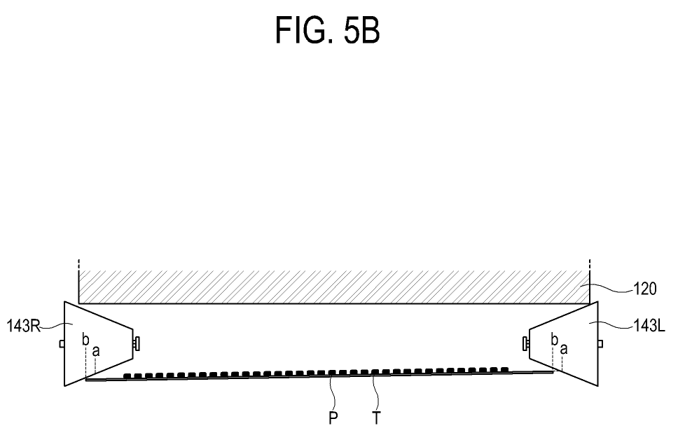

The contact preventing roller 143 and the auxiliary contact preventing roller 147 may contact the printing medium P. When the contact preventing roller 143 and the auxiliary contact preventing roller 147 contact printing media P having different sizes, the developer may get scraped onto the surface of the contact preventing roller 143 and the auxiliary contact preventing roller 147 at different locations along the length L (FIG. 5A) due to different side margins of the printing media P having different sizes. Also, the developer may get scraped onto the surface of the contact preventing roller 143 and the auxiliary contact preventing roller 147 because the positions of the opposite side edges of the printing medium P contacting the contact preventing roller 143 and the auxiliary contact preventing roller 147 are different according to whether the central feeding (CF) method or the side feeding (SF) method is used to feed the printing medium P along the feeding path. Accordingly, the contact preventing roller 143 and the auxiliary contact preventing roller 147 are tapered toward the inside of the printing medium P to contact the printing medium P. That is, the contact preventing roller 143 and the auxiliary contact preventing roller 147 have cone shapes which decrease in surface area toward the inside of the feeding path.

As shown in FIG. 5A, as the inclination angle α, which is formed between a central rotational axis and a surface of the contact preventing roller 143, increases, the surface of the contact preventing roller 143 which contacts the printing medium P decreases. However, if the inclination angle α is too large, the volume of the contact preventing roller 143 increases. Thus, the contact preventing roller 143 should be designed in consideration of the thickness of the developer and the thickness of the printing medium P. When the image forming apparatus 100 is a color image forming apparatus, a plurality of developers apply different color toners, such as cyan, magenta, yellow and black (CMYK) toners, which overlap each other, and the thickness of a developer image is thicker than when the image forming apparatus 100 is a mono image forming apparatus which uses a single developer. Thus, when the image forming apparatus 100 is a color image forming apparatus, the inclination angle α of the contact preventing roller 143 should be larger than an inclination angle of the contact preventing roller 143 when used in a mono image forming apparatus. It is understood that the inclination angle α of the contact preventing roller 143 may be identical to the inclination angle of the auxiliary contact preventing roller 147, and that the considerations taken into choosing the inclination angle α of the contact preventing roller 143 may also be taken into consideration when choosing the inclination angle of the auxiliary contact preventing roller 147. However, it is further understood that the inclination angle α of the contact preventing roller 143 is not required to be identical to the inclination angle of the auxiliary contact preventing roller 147.

According to an aspect of the present invention, the contact preventing roller 143 and the auxiliary contact preventing roller 147 each have a cone shape to reduce the contact area, but the contact preventing roller 143 and the auxiliary contact preventing roller 147 are not limited thereto. Alternatively, the contact preventing roller 143 and the auxiliary contact preventing roller 147 may have various shapes, including, for example, a rectangular, trapezoidal or polygonal cross section with respect to a feeding direction of the printing medium P. In these alternative embodiments, a projection or a plurality of projections may be formed on the surface of the contact preventing roller 143 and the auxiliary contact preventing roller 147 to minimize the contact area with respect to the printing medium P, although these projections are not required in all aspects.

The holder member 142 and the auxiliary holder member 146 respectively support the contact preventing roller 143 and the auxiliary contact preventing roller 147 to rotate with respect to the main body frame. According to an aspect of the present invention, the holder member 142 and the auxiliary holder member 146 protrude from opposite sides of the main body frame or are coupled with a planar surface of the guide member 119.

According to an aspect of the present invention, the auxiliary contact preventing unit 145 is provided between the photosensitive drum 123 and the main contact preventing unit 141 to prevent the printing medium P applied with the developer from contacting the bottom surface of the developing cartridge 120. That is, the auxiliary contact preventing unit 145 guides the printing medium P to be fed to the fusing unit 150, maintaining a gap between the printing medium P and the developing cartridge 120. Thus, the trailing edge of the printing medium P does not contact the developing cartridge 120 while being fed to the fusing unit 150.

As shown in FIG. 3, the fusing unit 150 fuses the developer to the printing medium P by heat and pressure. The fusing unit 150 includes a heating roller 151 which heats the printing medium P and a pressure roller 153 which faces the heating roller 151 and applies pressure to the printing medium P. Hereinafter, an image forming process of the image forming apparatus 100 according to an embodiment of the present invention will be described with reference to FIGS. 3 to 5B.

First, if the printing signal is transmitted from a host (not shown), such as a computer, the pickup roller 114 picks up the printing medium P from the knock-up plate 113 outside of the paper cassette 111. The leading edge of the picked-up printing medium P is aligned by the registration rollers 115 using any of various methods. For example, if the registration rollers 115 align the printing medium P by the central feeding (CF) method, the center of the printing medium P is aligned. It is understood that the registration rollers 115 may use other alignment methods as well, such as, for example, the side feeding (SF) method, or may use a combination of both the CF method and the SF method.

Then, the printing medium P is fed between the developing cartridge 120 and the transfer unit 130 through the feed roller 117 after passing between the registration rollers 115. The photosensitive drum 123 of the developing cartridge 120 transfers the developer to the printing medium P by a transfer voltage supplied from the transfer unit 130. After the photosensitive drum 123 applies the developer to the printing medium P, the printing medium P is fed to the fusing unit 150, with the opposite sides of the printing medium P supported by the contact preventing unit 140.

As shown in FIG. 5A, the opposite side edges of the printing medium P contact the left and right contact preventing rollers 143L and 143R at corresponding points labeled “a”. When the opposite side edges of the printing medium P contact the left and right contact preventing rollers 143L and 143R and, the developer, i.e., the toner T, is not scraped onto the left and right contact preventing rollers 143L and 143R, since the lengths L of the left and right contact preventing rollers 143L and 143R are shorter than the side margin of the printing medium P.

As shown in FIG. 5B, if the printing medium P is fed by the side feeding (SF) method, the printing medium P is aligned left of where the printing medium P would be aligned as compared to the central feeding (CF) method, and contacts the left and right contact preventing rollers 143L and 143R at corresponding points labeled “b,” which are to the left of the contact points “a” shown in FIG. 5A. The lengths L of the left and right contact preventing rollers 143L and 143R cover the alignment difference L3 (refer to FIG. 7) between the central feeding (CF) method and the side feeding (SF) method. Thus, even if the printing medium P is aligned to the left due to the side feeding method (SF), the left and right contact preventing rollers 143L and 143R prevent the right side of the printing medium P from scraping the developer onto the developing cartridge 120.

As described above, aspects of the present invention provide an image forming apparatus 100 which includes a roller type contact preventing unit 143 and an auxiliary roller type contact preventing unit 147 to support opposite side edges of a printing medium P and prevent the printing medium P from contacting the developing cartridge 120, even if the printing medium P deviates from a feeding path.

Also, aspects of the present invention provide an image forming apparatus 100 which includes a cone-shaped contact preventing roller 143 and auxiliary contact preventing roller 147 to minimize a contact area with a printing medium P and prevent a developer from being scraped onto a surface of the contact preventing roller 143 and the auxiliary contact preventing roller 147.

Further, aspects of the present invention provide an image forming apparatus 100 which includes a plurality of contact preventing units 141 and 145 to prevent contact between the developing cartridge 120 and a printing medium P.

Further, aspects of the present invention provide an image forming apparatus 100 in which a contact preventing roller 143 and an auxiliary contact preventing roller 147 are designed in consideration of various sizes of printing media P and various feeding methods of the printing media P, to cover various differences due to movement of the printing media P.

Although a few exemplary embodiments of the present invention have been shown and described, it will be appreciated by those skilled in the art that changes may be made in these exemplary embodiments without departing from the principles and spirit of the invention, the scope of which is defined in the appended claims and their equivalents.

What is claimed is:

1. An image forming apparatus, comprising:
a printing medium feeder which feeds a printing medium;
a developing cartridge which forms an image on the printing medium;
a fusing unit which fuses the image on the printing medium; and
a contact preventing unit which is provided between the developing cartridge and the fusing unit and line contacts or point contacts opposite sides of the printing medium within a predetermined length to prevent contact between the printing medium and the developing cartridge.

2. The image forming apparatus according to claim 1, wherein the contact preventing unit further prevents the printing medium from deviating off a feeding path a distance which is more than a predetermined length that is larger than a difference between a width of a smallest printing medium and a width of a largest printing medium fed by the printing medium feeder.

3. The image forming apparatus according to claim 1, wherein the printing medium feeder employs one of a central feeding method to feed the printing medium based on a location of a center of the printing medium, or a side feeding method to feed the printing medium based on a location of one of the sides of the printing medium and which shifts the printing medium towards one of the sides in comparison with the central feeding method, and
the contact preventing unit prevents the printing medium from deviating off the feeding path a distance which is more than a predetermined length that is larger than an alignment difference between the printing medium aligned by the central feeding method and the printing medium aligned by the side feeding method.

4. The image forming apparatus according to claim 1, wherein the contact preventing unit comprises a contact preventing roller.

5. The image forming apparatus according to claim 4, wherein the contact preventing roller is tapered toward an inside of the feeding path.

6. The image forming apparatus according to claim 5, wherein the contact preventing roller is shaped like a cone.

7. The image forming apparatus according to claim 5, wherein the contact preventing roller comprises a plurality of projections which are formed on a surface of the contact preventing roller which contacts one of the sides of the printing medium.

8. The image forming apparatus according to claim 1, further comprising:
a guide member which faces the developing cartridge and guides the printing medium to the contact preventing unit; and
an auxiliary contact preventing unit which is provided between the developing cartridge and the guide member to prevent the contact between the printing medium and the developing cartridge and to prevent the sides of the printing medium from deviating off the feeding path.

9. The image forming apparatus according to claim 5, wherein the contact preventing roller has a flat surface at an inclination angle formed between a central rotational axis of the contact preventing roller and a surface of the contact preventing roller which contacts one of the sides of the printing medium.

10. The image forming apparatus according to claim 9, wherein the inclination angle of the contact preventing roller is based on a thickness of a developer supplied from the developing cartridge.

11. The image forming apparatus according to claim 4, further comprising a pair of the contact preventing rollers to respectively contact the opposite sides of the printing medium.

12. An image forming apparatus, comprising:
a printing medium feeder which feeds a printing medium along a feeding path;
a developing cartridge located above the feeding path which forms an image on the printing medium; and
a contact preventing unit, comprising:
first and second contact preventing rollers to respectively block opposite sides of the printing medium from moving upwards and contacting the developing cartridge and from deviating sideways off the feeding path.

13. The image forming apparatus according to claim 12, wherein each of the first and second contact preventing rollers is tapered towards an inside of the feeding path.

14. The image forming apparatus according to claim 12, wherein each of the first and second contact preventing rollers is cone-shaped.

15. The image forming apparatus according to claim 12, wherein each of the first and second contact preventing rollers has a flat surface at an inclination angle which is formed between a central rotational axis and the flat surface and which contacts a corresponding one of the sides of the printing medium.

16. The image forming apparatus according to claim 15, wherein the inclination angle of each of the first and second contact preventing rollers is based on a thickness of a developer supplied from the developing cartridge.

17. The image forming apparatus according to claim 16, wherein the inclination angle of each of the first and second contact preventing rollers is increased if the thickness of the developer increases to reduce contact between the surface of the corresponding contact preventing roller and the developer.

18. A contact preventing unit to be used in an image forming apparatus having a developing cartridge located above a feeding path, comprising:
first and second contact preventing rollers to prevent opposite sides of a printing medium from moving upwards and contacting the developing cartridge and from deviating sideways off a feeding path; and
first and second holder members to respectively support the first and second contact preventing rollers at opposite sides of the feeding path.

19. The contact preventing unit of claim 18, wherein each of the first and second contact preventing rollers is tapered towards an inside of the feeding path.

20. The contact preventing unit of claim 18, wherein each of the first and second contact preventing rollers is cone-shaped.
